(19) United States
(12) Patent Application Publication
(10) Pub. No.: US 2004/0213933 A1
(43) Pub. Date: Oct. 28, 2004

(54) Low profile dilatation balloon

(75) Inventor: Ashish Varma, Galway (IE)

Correspondence Address: STERNE, KESSLER, GOLDSTEIN & FOX PLLC, 1100 NEW YORK AVENUE, N.W., WASHINGTON, DC, 20005, US

(73) Assignee: Medtronic AVE, Inc.

(21) Appl. No.: 10/419,955

(22) Filed: Apr. 22, 2003

(51) Int. Cl. B32B 1/08; B29C 47/20; B29C 71/00

(52) U.S. Cl. 428/36.9; 264/28; 264/209.1; 264/237; 264/211

(57) ABSTRACT

A process for producing a low-profile, high-strength dilatation catheter balloon is disclosed. The process comprises forming a tubular extrudate and quenching said extrudate in a cryogenic fluid. The quenched extrudate has morphology of a largely disordered material. The crystallinity in the extrudate is no more than 15%. The crystallinity of the extrudate is measured using X-ray crystallography or DSC. The extrudate is further processed in a mold in which the extrudate is longitudinally and radially stretched. The stretched extrudate is finally attached as a balloon to the distal end of a catheter.

### BACKGROUND OF THE INVENTION

1. Field of the Invention

The present invention relates to the field of balloon dilatation. Specifically, the present invention relates to a method of manufacturing a polymeric extrudate used for manufacturing dilatation balloons.

2. Related Art

Angioplasty balloons are currently produced by a combination of extrusion and stretch blow molding. The extrusion process is used to produce the balloon tubing, which essentially serves as a pre-form. This tubing is subsequently transferred to a stretch blow-molding machine capable of axially elongating the extruded tubing. U.S. Pat. No. 6,328,710 B1 to Wang et al., discloses such a process, in which a tubing pre-form is extruded and blown to form a balloon. U.S. Pat. No. 6,210,364 B1; U.S. Pat. No. 6,283,939 B1 and U.S. Pat. No. 5,500,180, all to Anderson et al., disclose a process of blow-molding a balloon, in which a polymeric extrudate can be stretched in both a radial and axial direction.

The materials used in balloons for dilatation are primarily thermoplastics and thermoplastic elastomers such as polyesters and their block co-polymers, pol yamides and their block co-polymers and polyurethane block co-polymers. U.S. Pat. No. 5,290,306 to Trotta et al., discloses balloons made from polyesterether and polyetheresteramide copolymers. U.S. Pat. No. 6,171,278 to Wang et al., discloses balloons made from polyether-polyamide copolymers. U.S. Pat. No. 6,210,364 B1; U.S. Pat. No. 6,283,939 B1 and U.S. Pat. No. 5,500,180, all to Anderson et al., disclose balloons made from block copolymers.

The unique conditions under which balloon dilatation is performed requires extremely thin-walled high-strength balloons. Balloon properties have historically been modified by varying the stretch ratios dictated by the initial diameter of the balloon tubing, the final diameter of the balloon, and the forming and heat setting temperatures. The level of radial orientation induced by stretching the pre-formed tubing determines the tensile strength of the polymer, and this, in turn, determines the wall thickness and burst pressure of the balloon. Varying the dimensions of the extrudate and parameters of the stretch-blow molding process, however, offers only a limited means of controlling the physical properties of the balloon. New processes are therefore needed to tailor the properties of the balloon and produce high-strength balloons for dilatation.

### SUMMARY OF THE INVENTION

It has been found that controlling the microstructure, and in particular the crystal structure, of the polymeric material of the tubular extrudate can enhance the final properties of the balloons for dilatation. The present invention, therefore, relates to the morphology of the initial balloon extrusion and a method for producing same with the view of significantly reducing the wall thickness of the balloon.

The present invention also relates to a process for forming a dilatation balloon, comprising extruding a polymeric material to form a tubular extrudate, quenching said tubular extrudate in a cryogenic fluid and forming a balloon from said tubular extrudate.

The present invention also relates to a tubular extrudate having an outer diameter of about 0.0100 to about 0.0900 inches, an inner diameter of about 0.0050 to about 0.0450 inches, comprising a polymer having no more than about 15% crystallinity.

It is to be understood that both the foregoing general description and the following detailed description are exemplary and explanatory and are intended to provide further explanation of the invention as claimed.

### DETAILED DESCRIPTION OF THE INVENTION

One embodiment of the present invention relates to a process for producing a low-profile dilatation catheter balloon, comprising forming a tubular extrudate and quenching said extrudate in a cryogenic fluid. The term dilatation refers to the types of balloons included in the present invention. Dilatation, for example, includes, but is not limited to angioplasty balloons and stent delivery balloons.

It is desirable to minimize the wall thickness of the balloon to create a low profile, while maintaining a high degree of strength in the balloon. This allows a surgeon to use the balloon in very small arteries that may have a large degree of blockage or plaque build-up, and provides the surgeon with maximum flexibility to inflate the balloon without bursting it. In order to maximize strength in the balloon, the polymeric balloon must have a highly ordered morphology. One aspect of the invention is therefore related to a method of producing a highly-oriented macromolecular system by significantly reducing the level of crystallinity in tubular extrudate. The microstructure in the tubular extrudate, therefore, lacks large, spatially well-defined regions of order. Such morphology serves to greatly enhance the levels of molecular orientation that may be introduced due to enhanced drawability.

Dilatation is used herein to refer to the expandability of the balloon. Balloons of the present invention are expandable about 2% to about 40% greater than the original balloon size. Preferably, the expandability of the balloon is in the range of about 5% to about 20%.

Expandability is one measure of the physical properties of the balloon. Other measures include the hoop (or tensile) strength of the balloon. Hoop strength is directly related to the maximum amount of pressure the balloon can withstand, for a given wall thickness, without failing. The balloons of the present invention have hoop strengths upon dilatation of about 20,000 to about 75,000 p.s.i.

The factors affecting the physical properties of a dilatation balloon include, but are not limited to: the morphology of the polymer(s), degree of molecular alignment, the molecular weight of the polymer(s), the chemical structure of the repeat units in the polymer(s), and the presence of plasticizer(s), modifier(s) and/or impurities. The morphology of the polymer can include amorphous areas with little or no ordering in the polymer chains, crystalline areas with high degrees of ordering in the polymer chains, herein referred to as crystallites, and areas in between these two states, which have some degree of ordering. Balloons made of polymers having areas of order in the polymer chains tend to have higher strength than polymers that are disordered and amorphous. Controlling the morphology and molecular ordering of the polymer, therefore, is one way to control the strength of the balloon. The degree of ordering in a polymer can be measured by any method known to one of ordinary skill in the art. For example, X-Ray analysis of the polymer can be performed to measure the degree of ordering.

Balloon strength is also affected by the choice of material. Materials for use in the extrudate and resultant balloon of the present invention include any polymeric material that imparts a high degree of strength to the final balloon. Such materials include, for example, but are not limited to: polyalkanes, polyhaloalkanes, polyalkenes, polyethers, polyesters, polycarbonates, polyamides, polyurethanes, polysulfones, polyketones, polysaccharides, polyamines, polyimines, polyphosphates, polyphosphonates, polysulfonates, polysulfonamides, polyphosphazenes and polysiloxanes. Specific examples of polymers for use in the invention include, but are not limited to: high density polyethylene; low density polyethylene; atactic, isotactic and syndiotactic polypropylene, polyamides such as nylon-11 and nylon-12; and polyesters such as polyethylene terephthalate. Specific examples of copolymers for use in the invention include, but are not limited to: polyamide-polyether copolymers such as the PEBAX® 33 series available from Atochem, North America, Inc. (Philadelphia, Pa.); polyurethane-polyether copolymers such as TECOFLEX® and TECOTHANE® both sold by Thermedics, Inc. (Wilmington, Me.); polyurethane-polyester copolymers such as PELLETHANE® sold by Dow Chemical Company (Midland, Mich.); and polyester-polyethers such as the HYTREL® resins sold by DuPont Chemical, Inc. (Wilmington, Del.). The molecular weight of a polymeric material used in the invention is in the range of about 5,000 to about 5,000,000.

The extrudate further comprises a plasticizer. Plasticizer is used herein to mean any material that can decrease the flexural modulus of a polymer. The plasticizer may influence the morphology of the polymer and may affect the melting temperature and glass transition temperature. Examples of plasticizers include, but are not limited to: small organic and inorganic molecules, oligomers and small molecular weight polymers (those having molecular weight less than about 50,000), highly-branched polymers and dendrimers. Specific examples include: monomeric carbonamides and sulfonamides, phenolic compounds, cyclic ketones, mixtures of phenols and esters, sulfonated esters or amides, N-alkylolarylsulfonamides, selected aliphatic diols, phosphite esters of alcohols, phthalate esters such as diethyl phthalate, dihexyl phthalate, dioctyl phthalate, didecyl phthalate, di(2-ethylhexy) phthalate and diisononyl phthalate; alcohols such as glycerol, ethylene glycol, diethylene glycol, triethylene glycol, oligomers of ethylene glycol; 2-ethylhexanol, isononyl alcohol and isodecyl alcohol, sorbitol and mannitol; ethers such as oligomers of polyethylene glycol, including PEG-500, PEG 1000 and PEG-2000; and amines such as triethanol amine.

The extrudate optionally further comprises a modifier. Modifier is used herein to refer to any material added to the polymer to affect the polymer's properties. Examples of modifiers for use in the invention include: fillers, antioxidants, colorants, crosslinking agents, impact strength modifiers, drugs and biologically active compounds and molecules.

According to the present invention, the extrudate is formed in a tubular shape by an extruder. Extruders for use in the present invention include any extruder capable of forming tubular shaped articles. Examples of extruders include, but are not limited to, single screw and double screw. The processing temperature depends on the actual polymer system being used. For example, when extruding Nylon 12 the extruder may be heated such that the melt temperature is about 220° C. to about 360° C., preferably about 260° C. to about 320° C. Tubular is used herein to mean a hollow, cylindrical-shaped article having an inner diameter, an inner circumference, an outer diameter and an outer circumference with a wall thickness between the outer and inner circumferences. The outer diameter for the tubular extrudate is about 0.0100 to about 0.0900 inches. The inner diameter for the tubular extrudate is about 0.0050 to about 0.0450 inches. As the extrudate exits the extruder and begins cooling, the polymer chains begin to crystallize (in semi-crystalline polymers). Cooling the extrudate slowly produces a large number of crystallite sites. Each crystallite site will grow larger in size as the extrudate is cooled more slowly. In a standard extrusion process employed in the current art, using water as a cooling medium, the extrudate may therefore develop a relatively large degree of crystallinity. For example Nylon 12 tubing may be 20-25% crystalline. Quenching the extrudate in a cryogenic fluid, however, freezes the extrudate in a mostly amorphous state. The morphology of the polymeric material, therefore, has low degree of order and a high degree of disorder in the polymer chains, meaning there is a limited number of small, imperfect, crystallites and a large amount of amorphous polymer. The amount of crystallinity, for example in Nylon 12, in the polymeric extrudate, from these crystallites, is about 1% to about 15%, preferably less than 10%. This represents the total amount of crystallinity in the polymeric extrudate, meaning that about 1% to about 15%, preferably less than 10%, of the polymeric material is crystalline. This process, therefore, produces a polymeric tubular extrudate having less than 15% crystallinity.

Crystallinity in an extrudate is measured by any method known to one of ordinary skill in the art. Examples include, but are not limited to X-Ray diffraction, Differential Scanning Calorimetry (DSC). One of ordinary skill in the art also understands how to use these techniques to calculate the percentage crystallinity in a sample of extrudate.

Cryogenic fluids for use in quenching include any fluid that is cold enough to freeze the extrudate in a disordered state, meaning any fluid at a temperature of about −300° C. to about 0° C. Examples include, but are not limited to: liquid nitrogen; liquid helium; liquid oxygen; liquid carbon dioxide; mixtures comprising solid carbon dioxide and a fluid such as acetone, methanol, ethanol and isopropanol; and solid carbon dioxide.

According to the present invention, the extrudate is quenched and immediately further processed. Further processing comprises forming a balloon from the tubular extrudate. Alternatively, when the extrudate is not immediately further processed, the extrudate is stored for a period of time at a temperature of about −1° C. to about 10° C. before further processing. The time period between extruding and further processing can be about 12 hours to about 200 hours. Storing the extrudate in a reduced-temperature atmosphere prevents further crystallization of the polymer chains in the polymeric extrudate, which could adversely affect the final properties of the balloon.

After forming the tubular extrudate, the extrudate is further processed in a balloon-forming step. The balloon-forming step is performed according to any one of the methods known to one of skill in the art. For example, the stretching method of U.S. Pat. No. 5,948,345 to Patel et al. can be used.

According to the method of Patel et al., a length of tubing comprising a biaxially orientable polymer or copolymer is first provided having first and second portions with corresponding first and second outer diameters. Also provided is a mold having a generally cylindrical shape. The mold comprises a first, second and third portion having a corresponding first, second and third mold diameter. The first outer diameter of the tubing is larger than the first mold diameter. The tubing is placed in the mold and heated above the glass transition temperature of the polymer. Pressure is applied to the tube and the tube is longitudinally stretched such that it expands radially during the stretching. The tube is stretched about 4 to about 7 times the length of the tube's original length. A pressure of about 300 to about 500 p.s.i. is applied. A second higher pressure, about 15% to about 40% higher than the first pressure, is then applied and the tube is finally cooled below the glass transition temperature of the polymer. One skilled in the art appreciates that much of the stretching process can be performed by automated equipment in order to lower per unit costs. Upon completion of the stretching, the balloon is attached to the distal end of a catheter body to complete the production of the catheter balloon.

While the invention has been particularly shown and described with reference to preferred embodiments thereof, it will be understood by those skilled in the art that various changes in form and details may be made therein without departing from the spirit and the scope of the invention.

What is claimed is:

1. A process for producing a polymeric extrudate for use as a dilatation balloon, comprising:
a) extruding a polymeric material to form a tubular extrudate; and
b) quenching said tubular extrudate in a cryogenic fluid.

2. The process of claim 1, wherein the tubular extrudate is formed from a composition comprising a polymer selected from the group consisting of polyamide, polyether, polyester, polyurethane, polyethylene, polypropylene.

3. The process of claim 1, wherein the tubular extrudate is formed from a composition comprising a polyamide and a plasticizer.

4. The process of claim 3, wherein the tubular extrudate is formed from a composition comprising:
(1) a polymer selected from the group consisting of nylon-11 and nylon-12, nylon-6, nylon-7, nylon 6.12, nylon 6.6, nylon 4.6, nylon 6.10, nylon 6.9; and
(2) a plasticizer selected from the group consisting of carbonamides and sulfonamides, phenolic compounds, cyclic ketones, mixtures of phenols and esters, sulfonated esters or amides, N-alkylolarylsulfonamides, aliphatic diols and phosphite esters of alcohols.

5. The process of claim 1, wherein the tubular extrudate is formed from a composition comprising a copolymer selected from the group consisting of polyether-amide, polyester-amide, polyamide-polyurethane, polyether-urethane, polyester-urethane, polyether-ester, polyalkane-polyether, polyalkane-polyamide, polyalkane-polyester, and polyalkane-polyurethane.

6. The process of claim 1, wherein step (b) further comprises:
quenching said extrudate in a cryogenic fluid held at a temperature of about −300° C. to about 0° C.

7. The process of claim 1, wherein step (b) further comprises:
quenching said extrudate in a cryogenic fluid selected from the group consisting of liquid nitrogen, liquid oxygen, liquid helium and liquid carbon dioxide.

8. The process of claim 1, further comprising:
(c) holding said extrudate for about 12 hours to about 200 hours at a temperature of about −10° C. to about 10° C.

9. The process of claim 1, wherein said tubular extrudate comprises a polymer having no more than about 15% crystallinity.

10. The process of claim 1, wherein said tubular extrudate comprises a polymer having no more than about 10% crystallinity.

11. The process of claim 1, wherein said tubular extrudate is extruded in step (a) to have an outer diameter of about 0.0100 to about 0.0900 inches and an inner diameter of about 0.0050 to about 0.0450 inches.

12. A polymeric tubular extrudate prepared according the process of claim 1.

13. A process for forming a dilatation balloon, comprising:
(a) extruding a polymeric material to form a tubular extrudate;
(b) quenching said tubular extrudate in a cryogenic fluid;
(c) forming the dilatation balloon from said quenched tubular extrudate.

14. The process of claim 13, further comprising:
(d) holding said extrudate for about 12 hours to about 200 hours at a temperature of about −10° C. to about 10° C. prior to step (c).

15. A balloon prepared according to the process of claim 13.

16. A tubular extrudate for forming a dilatation balloon having an outer diameter of about 0.0100 to about 0.0900 inches, an inner diameter of about 0.0050 to about 0.0450 inches, comprising a polymer having no more than about 15% crystallinity.

17. The extrudate of claim 16, wherein said polymer is a polyamide.

18. The extrudate of claim 16 further comprising a plasticizer.
